(19) United States
(12) Patent Application Publication
(10) Pub. No.: US 2003/0007216 A1
(43) Pub. Date: Jan. 9, 2003

(54) Long haul transmission in a dispersion managed optical communication system

(76) Inventors: Andrew Roman Chraplyvy, Matawan, NJ (US); Xiang Liu, Eatontown, NJ (US); Xing Wei, New Providence, NJ (US); Chunhui Xu, Piscataway, NJ (US)

Correspondence Address: Docket Administrator (Room 3J-219), Lucent Technologies Inc., 101 Crawfords Corner Road, Holmdel, NJ, 07733-3030, US

(21) Appl. No.: 09/990,964

(22) Filed: Nov. 21, 2001

Related U.S. Application Data
(60) Provisional application No. 60/299,858, filed on Jun. 21, 2001.

(51) Int. Cl. H04J 14/02; H04B 10/00

(52) U.S. Cl. 359/161; 359/124

(57) ABSTRACT

Phase shift keying (PSK) or differential phase shift keying (DPSK) used as the coding scheme in a high bit rate, long haul dispersion-managed optical transmission system, in which the signaling format is RZ. The system can combine multiple individual channels with different wavelengths in a WDM or dense wavelength division multiplexed (DWDM) arrangement. Dispersion management can be provided using several techniques, such as by using dispersion managed solitons, quasi-linear transmission or conventional RZ transmission with pre-compensation and post-compensation.

### CROSS-REFERENCE TO RELATED APPLICATION

This application claims priority of Provisional Application Serial No. 60/299,858 which was filed Jun. 21, 2001.

### TECHNICAL FIELD

The present invention relates to optical communications, and more particularly to an arrangement for dispersion managed transmission of return to zero (RZ) pulses using phase shift keying (PSK) or differential phase shift keying (DPSK), that can be used in a high bit rate (e.g., 10 Gbit/s or 40 Gbit/s) long haul (or ultra long haul) optical communication system, including a wavelength division multiplexed (WDM) system.

### BACKGROUND OF THE INVENTION

Development of high bit rate (e.g., 40 Gbit/s) optical transmission systems have been hampered by intra-channel non-linear penalties, such as intra-channel cross phase modulation (XPM) among adjacent overlapping bits that mostly leads to timing jitter, as well as by intra-channel four wave mixing (FWM), that mostly leads to amplitude fluctuations. Use of high bit rates in conjunction with long haul and ultra-long haul (ULH) transmission, particularly in the environment in which multiple channels are combined in a WDM or DWDM system, has been additionally difficult, due to both the worsened nonlinear impairments and the increased amplifier spontaneous emission (ASE) noise, which leads to degradation of pulses as they propagate through an optical fiber path from a transmitter to a receiver, and various undesirable inter-channel effects, such as inter-channel XPM and FWM.

While various techniques have been attempted to reduce or eliminate the effects of noise and fiber nonlinearity, these techniques have had varying degrees of success. Some techniques have proven useful in single wavelength channel systems, but do not work well in the context of WDM systems, in which many different wavelengths are combined in a single optical transmission medium. Other techniques have used various combinations of dispersion management in the optical communication medium as well as different coding techniques in the transmitter and receiver. However, until now, no solution has proved effective in the environment of long (or ultra long) haul transmission of multiple WDM channels, on a cost effective basis.

### SUMMARY OF THE INVENTION

In accordance with the present invention, phase shift keying (PSK) or differential phase shift keying (DPSK), in contrast to conventional on-off keying (OOK), is used as the coding scheme in a high bit rate, long haul dispersion-managed optical transmission system, and the signaling format is RZ, in contrast to NRZ. Thus, in terms of light intensity, there is always one RZ-pulse in every bit slot. The system can combine multiple individual channels with different wavelengths in a WDM or dense wavelength division multiplexed (DWDM) arrangement. Dispersion management can be provided using several techniques, such as by using dispersion managed solitons, quasi-linear transmissions or conventional RZ transmissions.

In one embodiment of the invention, at the transmitter, an electrical signal representing the data is differentially encoded and used to modulate the phase of a stream of high bit rate (e.g., 40 Gbit/s) RZ optical pulses. Many such data streams are combined in a wavelength division multiplexer and transmitted to a remote receiver via dispersion-managed fiber spans. At the receiver, the signal is wavelength division demultiplexed, and the encoded data in each wavelength channel is recovered by a DPSK receiver, which usually consists of a delay demodulator and a balanced detector.

In an alternative embodiment, the data is not differentially encoded, but rather is directly used to modulate the phase of a stream of RZ optical pulses.

In either embodiment, the transmission medium and laser power may be managed so that the pulse transmission comprises solitons.

By virtue of the use, in accordance with the present invention, of DPSK (or other PSK formats), the XPM penalty is mostly eliminated by removing the intensity-pattern dependence. Compared with OOK, DPSK is more tolerant to ASE noise because of its higher receiver sensitivity, especially when a balanced receiver is used, and allows for transmission with lower optical power. This also reduces the FWM penalty, for example, a 3 dB reduction in power leads to 6 dB reduction in the FWM effects.

### BRIEF DESCRIPTION OF THE DRAWINGS

The present invention will be more fully appreciated by consideration of the following detailed description, which should be read in light of the drawing in which:

FIG. 1 is a block diagram of one embodiment of a high bit rate (e.g., 40 Gbit/s) long haul (or ultra long haul) wavelength division multiplexed (WDM) optical communication system arranged in accordance with the principles of the present invention to use dispersion managed transmission of return to zero (RZ) pulses and phase shift keying (PSK);

FIG. 2 is an illustration of sample data to be transmitted using the system of FIG. 1, and the signals present at various points in the system;

FIG. 3 is block diagram of a system similar to the system shown in FIG. 1, but which uses differential phase shift keying in lieu of phase shift keying;

FIG. 4 is an illustration of sample data to be transmitted using the system of FIG. 3, and the signals present at various points in the system;

FIG. 5 illustrates one arrangement for receiver 150 of FIG. 1;

FIG. 6 is an illustration of the dispersion map and accumulated dispersion in a system in which dispersion management is employed in the optical communication medium connecting the transmitter to the receiver;

FIG. 7 is a diagram of dispersion vs. distance for the dispersion managed soliton transmission system, where residue span dispersion is compensated by self-phase modulation; and

FIG. 8 is a diagram illustrating pre-compensation and post-compensation in an RZ dispersion management transmission environment.

### DETAILED DESCRIPTION

The following acronyms are used in this application:

| | |
|---|---|
| ASE | amplifier spontaneous emission |
| ASK | amplitude shift keying |
| DMS | dispersion managed soliton |
| DPSK | differential phase shift keying |
| WDM | wavelength division multiplexing |
| FWM | four wave mixing |
| OOK | on-off keying |
| PMD | polarization mode dispersion |
| PSK | phase shift keying |
| QPSK | quadrature phase shift keying |
| SPM | self-phase modulation |
| ULH | ultra-long haul |
| XPM | cross phase modulation |

In considering the following detailed description, the disclosure contained in co-pending application entitled “Long Haul Optical Communication System” filed concurrently herewith of behalf of applicants Xiang Liu, Xing Wei and Chris Xu, and assigned to the same assignee as the present invention, which disclosure is hereby incorporated by reference, should also be considered.

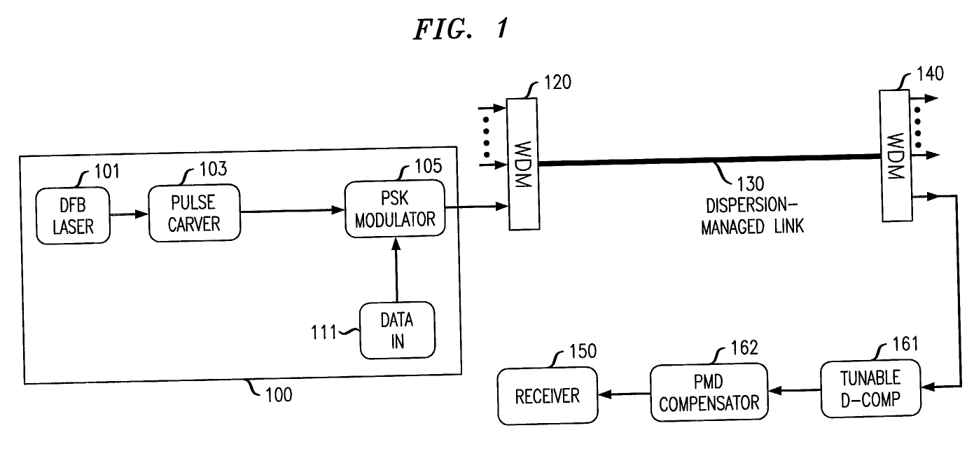

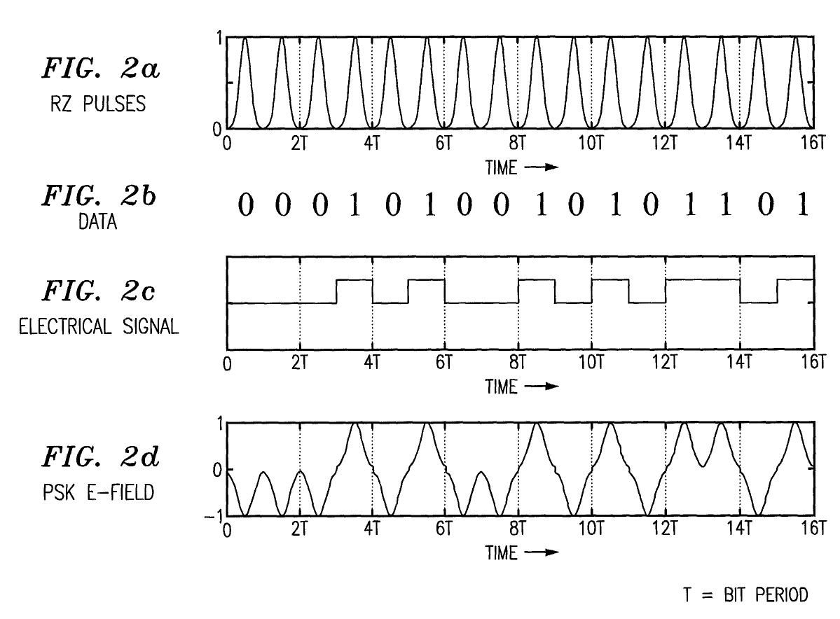

Referring now to FIG. 1, there is shown a block diagram of one embodiment of a high bit rate (e.g., 40 Gbit/s) long haul (or ultra long haul) wavelength division multiplexed (WDM) optical communication system arranged in accordance with the principles of the present invention to use dispersion managed transmission of return to zero (RZ) pulses and phase shift keying (PSK). FIG. 1 should be read in light of FIG. 2, which is an illustration of sample data to be transmitted using the system of FIG. 1, and the signals present at various points in the system.

In FIG. 1, a transmitter designated generally as 100 includes a continuous wave (CW) distributed feedback (DFB) laser 101, the output of which is applied to and shaped by a pulse carver 103. Accordingly, the output of pulse carver 103, which is shown as waveform 2(a) in FIG. 2, is a stream of return to zero (RZ) optical pulses of uniform amplitude, illustratively having a high bit rate (e.g. 10 Gbit/s or 40 Gbit/s). Note here that the purpose served by pulse carver 103, namely, to process a continuous wave laser signal to generate an RZ pulsed signal, can be provided by alternative elements, such as using a pulsed laser instead of the CW-DFB laser 101. Alternatively, the RZ signal can be generated within PSK modulator 105 that is described below.

The RZ signal output from pulse carver 103 is applied to one input of a PSK modulator 105, which may, for example, be a LiNbO3 phase modulator or a LiNbO3 Mach-Zehnder modulator biased at its transmission null point. The data to be transmitted from transmitter 100 to a remote receiver designated generally as 150, which, as an example, may be the series of 0's and 1's illustrated in FIG. 2(b), originates from or is available at a data input 111. The data in FIG. 2(b) corresponds to the electrical signal shown in FIG. 2(c), which is applied to the second input of PSK modulator 105. As a result, the phase of the output from the PSK modulator 105 is varied (modulated) in accordance with the input data, producing a PSK signal having the E-field shown in FIG. 2(d). It should be noted that the characteristics of this E-field are that, for each bit interval, the E-field values both starts at and ends at zero. If the data is a “1”, the E-field value at the approximate mid-point of the corresponding bit interval is positive, representing a phase of 0; otherwise, if the data is a “0”, the E-field value at the approximate mid-point of the corresponding bit interval is negative, representing a phase of π.

The output of PSK modulator 105 in FIG. 1 may represent one channel in a WDM system that includes a plurality of other transmitters arranged in a manner similar to transmitter 100, but which operate at different wavelengths. In the WDM environment, the output of PSK modulator 105 is applied to an input of wavelength division multiplexer 520, the output of which is coupled to a long haul or ultra long haul dispersion compensated transmission medium designated generally as 130. The transmission medium includes amplification mechanisms to compensate for the losses incurred in the optical fiber as well as in the system components. Various optical amplifiers, which can be discrete or distributed, and can use various technology, such as EDFA, Raman amplification, coherent amplification such as parametric amplification, etc., can achieve the desired level of amplification. A number of techniques for dispersion compensation can be used, as will be more fully described below.

At the remote termination of transmission medium 130, if multiple wavelengths are present, they are separated in a WDM demultiplexer 140, which applies each individual wavelength to a separate PSK receiver, illustratively receiver 150, so as to recover the original data. If desired, a tunable dispersion compensator and a polarization mode dispersion (PMD) compensator may be interposed between demultiplexer 140 and receiver 150, in order to reduce the effects of non-uniform residue dispersion among different wavelength channels and PMD, respectively.

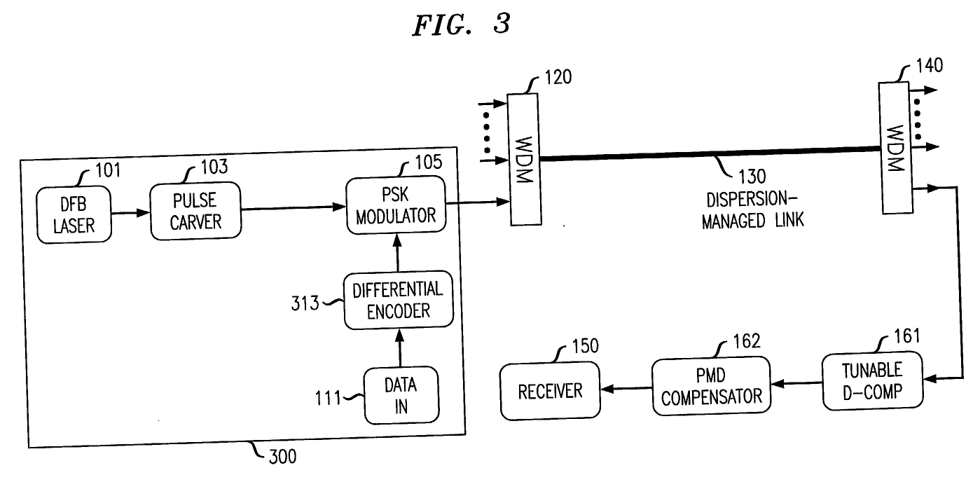

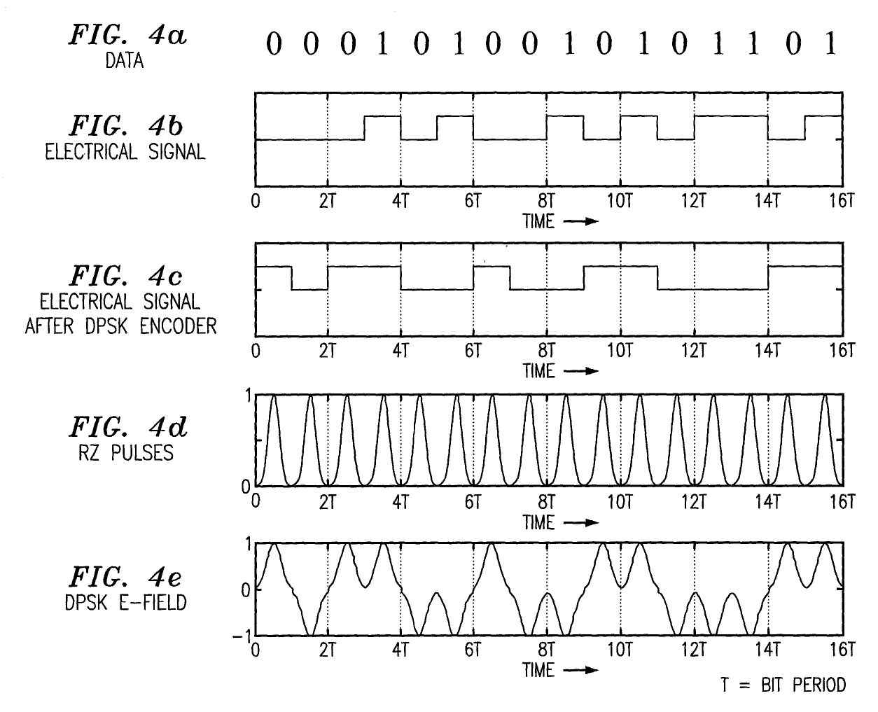

Referring now to FIG. 3, there is shown a block diagram of a system similar to the system shown in FIG. 1, but which uses differential phase shift keying in lieu of phase shift keying. The same sample data is to be transmitted using the system of FIG. 3, as shown in FIG. 4(a), and its electrical representation shown in FIG. 4(b) is also the same. However, in this arrangement, the data is first applied to a differential encoder 390 in transmitter 300, which is arranged to produce the output shown in FIG. 4(c). FIG. 4(c) shows the differentially encoded data in which each transition (either from “0” to “1” or from “1” to “0”) corresponds to a digital “0” in the original data stream and each non-transition (a bit remains the same as the previous bit) corresponds to a digital “1” in the original data stream. The differentially encoded signal is then used to modulate the phase of the light pulses. Such phase modulation can be achieved either with a LiNbO3 phase modulator or a LiNbO3 Mach-Zehnder modulator biased at its transmission null point. The electrical waveform in FIG. 4(c), corresponding to the output from differential encoder 390 of FIG. 3, is applied to PSK modulator 105, whose output E-field is shown in FIG. 4(e). Note again that this waveform output from modulator 105 is an RZ waveform, returning to zero at the beginning of every bit interval. Differential data is encoded only with respect to the phase of the optical signal, and the intensity profile of the signal is unchanged, i.e., it is still an RZ signal. As with the arrangement of FIG. 1, the output of transmitter 300 can be applied to a WDM multiplexer before being transmitted to a remote receiver via dispersion compensated medium 130.

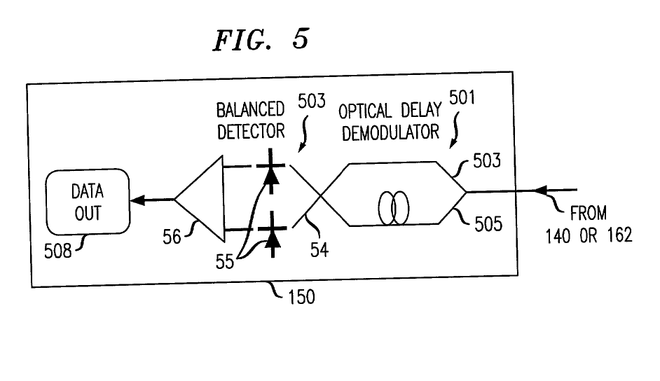

Receiver 150 may, as shown in FIG. 5, include a delay demodulator 501 having two arms 503, 505 with a path length difference corresponding to one bit period. The PSK signal is applied to both arms, so that when the delayed and non-delayed signals are combined, the output represents the data or inverted data depending on the type of interference. The output of demodulator 501 is then sent to a balanced detector 504, which may comprise a pair of diodes 555 and a differential amplifier 556, and the output of detector 504 is made available at data output 508.

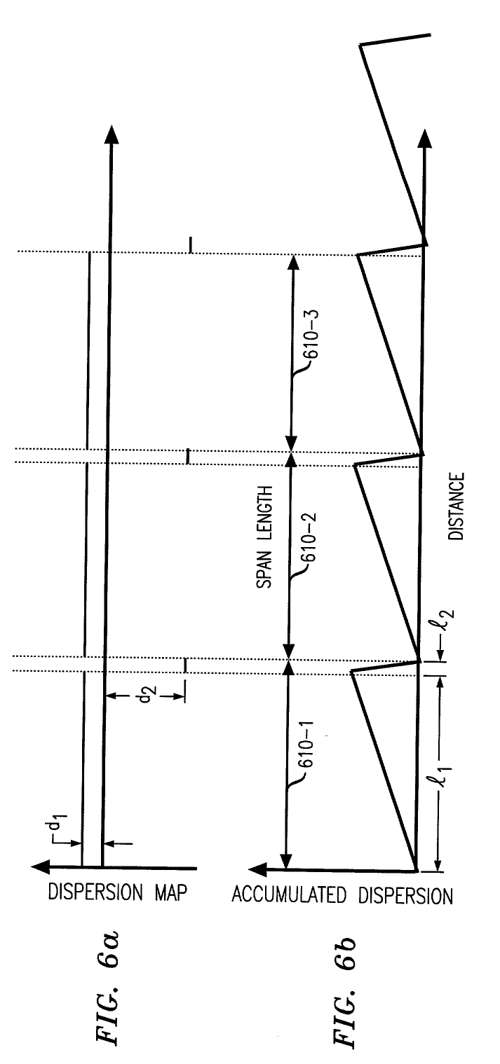

In accordance with the present invention dispersion compensation in the optical transmission medium can be achieved in a variety of ways, such as by using a dispersion managed soliton (DMS) system designed to reduce nonlinear impairments by compensating self-phase modulation (SPM) with dispersion, and by eliminating intra-channel pulse interaction through the control of “pulse-breathing”. This can be implemented by the use of multiple fiber spans between transmitter and receiver, where each span comprises contiguous regions having negative and positive dispersion fibers. As shown in FIG. 6, such a transmission arrangement may comprise a series of spans 610-1, 610-2, 610-3, etc. of equal length, wherein each span includes a first region of length L₁ with a positive dispersion D₁, and a contiguous second region of length L₂ with a negative dispersion D₂.

The dispersion map and plot of dispersion vs. distance in a dispersion managed transmission medium arranged for the transmission of solitons, is shown in FIGS. 6(a) and 6(b), respectively. As shown in FIG. 6(b), as distance along the fiber increases within span 610-1 from the beginning of the span toward the transition between the first and second regions, the accumulated dispersion increases linearly; however, within the second region, the dispersion is reversed, and the accumulated dispersion decreases linearly and dramatically, to return almost to the zero level. The dispersion compensation is repeated for the remaining spans 610-2, 610-3, etc., in the same fashion.

The use of dispersion managed solitons in connection with the present invention is advantageous, because while collisions between solitons in different WDM channels still occur in optical communication medium 130, each WDM channel has identical, uniform intensity pattern, and the collisions are thus the same for all solitons. The net effect of the collisions is a uniform shift in soliton arrival. Thus, no timing jitter is introduced.

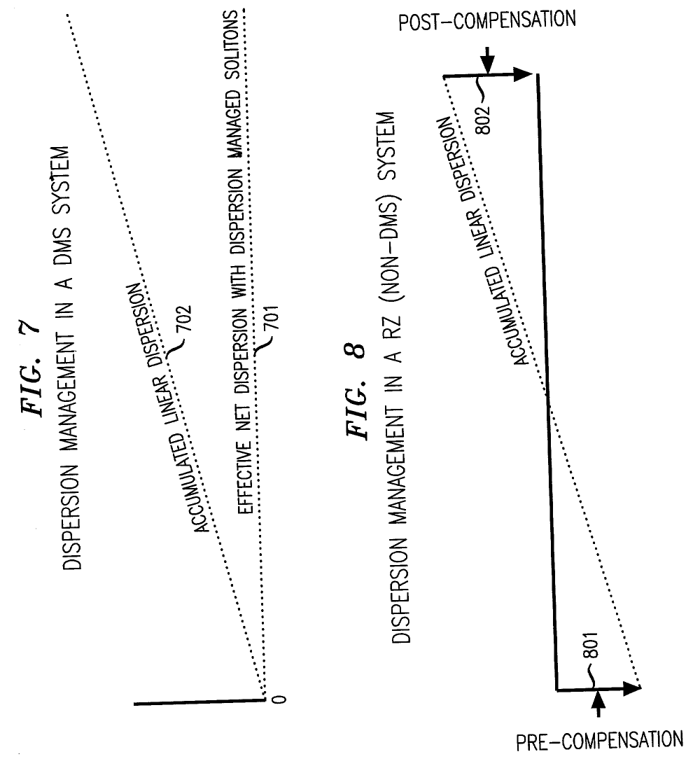

FIG. 7 is a diagram illustrating the degree of dispersion experienced across a dispersion compensated optical transmission medium when solitons, on the one hand, and other forms of RZ dispersion management, on the other hand, are used. In the case of dispersion managed solitons, the effective net dispersion, as shown by curve 701, is approximately constant across the entire length of the medium (x axis), because SPM compensates the residue span dispersion. In the case of other forms of RZ dispersion management, the accumulated linear dispersion changes gradually, as shown in curve 702 and is compensated by the post-dispersion compensation 802.

In order to optimize the system performance when an RZ dispersion management technique is used, distance-dependent pre-compensation and post-compensation may be employed. Thus, as shown in FIG. 8, a pre-compensator located at the beginning portion of an optical transmission medium or segment may be arranged to introduce a first compensating distortion 801, while a post-compensator located at the end portion of an optical transmission medium or segment may be arranged to introduce a second compensating distortion 802. As a result, the distortion introduced over the span or segment is essentially removed.

Another technique known as pseudo-linear transmission (sometimes referred to as quasi-linear transmission) can also be used for the purpose of dispersion management in conjunction with the present invention. (See, for example, U.S. patent application Ser. No. 09/372486 filed on Aug. 12, 1999 on behalf of R.-J. Essiambre, B. Mikkelsen, and G. Raybon, and entitled “Modulation format with low sensitivity to fiber nonlinearity”, which application is assigned to the same assignee as the present application, and which is incorporated herein by reference.) This technique uses very short (compared to the bit period) pulses that disperse very quickly as they propagate along a fiber. The same effect can also be achieved by using large pre-dispersion compensation. This is advantageous because such pulses have reduced path-averaged peak power and are thus more immune to optical nonlinearities than are conventional pulses

Some details of an experimental system embodying the present invention will be useful. A WDM DMS DPSK system, for example, has many spans, with each span consisting of 100 km of TWRS or LEAF fiber (D=4 ps/km/nm) and a dispersion compensating module made of DCF (D=−104 ps/km/nm). The length of the DCF is chosen to give the designed path-averaged dispersion (Davg). The soliton pulse trains had a 33% duty cycle. The channel spacing is 50 GHz. A 40 GHz FWHM 4th order Gaussian filter was used to demultiplex the channels, and the detection scheme for the DPSK DMS was a one-bit delayed differential direct detection. A 5th-order Bessel filter with FWHM of 0.7 bit-rate is used post-detection.

Based upon our simulations, we have verified that dispersion of the system, especially at high bit rates of 40 Gbit/s and beyond, which were previously thought to destroy the constant intensity profile of a WDM channel, will not noticeably reduce the benefit of DPSK-RZ. We found that intra-channel XPM effects are much reduced with DPSK-RZ and the inter-channel XPM and FWM effects were small to begin with in these systems. Thus, DPSK-RZ remains effective even in the presence of dispersion. Indeed, our numerical simulations show significant improvement in system reach and performance at 40 Gbit/s over conventional RZ systems.

The advantageous use of PSK or DPSK encoding in the present invention is contrary to conventional approaches currently available to persons skilled in the art. For example, an early study [see J. P. Gordon and L. F. Mollenauer, Optics Letters, Vol. 15, p. 1351, (1990)] about phase noise caused by ASE and SPM in a single channel PSK system placed severe restrictions on PSK in a LH and ULH optical transmission system, and discouraged application of this coding method as a viable alternative. Further theoretical study and numerical simulation for conventional solitons showed excessive phase noise at long transmission distances and the need for “in-line” filters to control phase noise [see M. Hanna, et al., Optics Letters, Vol. 24, p732, (1999)]. In a recent experimental investigation [see M. Hanna et al., Electronics Letter, Vol. 37, p644, (2001)], conventional DPSK solitons achieved an error-free transmission distance of ˜1000 km, significantly less than OOK soliton systems. However, in view of the present need for long reach and high bit rate WDM systems, we have recognized, for the first time, the value and feasibility of RZ-DPSK for long reach high bit rate WDM systems. Although DPSK has been proposed before for WDM systems [see M. Rohde, et al., Electronics Letters, Vol. 36, 1483-1484 (2000)], the desire to have constant intensity in every WDM channel in order to reduce nonlinear penalties has inevitably lead to NRZ-DPSK, rather than RZ-DPSK. It was not until recently did we realize that constant intensity is not necessary and that RZ-DPSK has significant advantages over NRZ-DPSK in LH and ULH transmission, such as reduced nonlinear penalties, higher tolerance to first-order PMD, and smaller inter-symbol interference.

While in the previous description, the present invention was applied in the context of a high bit rate system, it is to be understood that a RZ-DPSK technique as described above can also be used with systems with a variety of different bit-rates, as well as with many different fiber types and dispersion maps. For example, satisfactory performance can also be obtained with standard single mode fiber.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

I/We claim:

1. An optical communication system arranged to transmit input data from a transmitter to a remote receiver, said system comprising
means for encoding said input data by modulating the phase of a RZ carrier in accordance with said input data, and
means for transmitting said phase modulated RZ carrier from said transmitter to said receiver via a dispersion managed optical transmission medium.

2. A optical communication system comprising
means for generating an RZ carrier signal,
means for modulating the phase of said RZ carrier signal in accordance with an input data stream, and
means for applying the phase modulated signal generated by said modulating means to a dispersion managed optical transmission link.

3. An arrangement for transmitting digital data from an originating location to a remote destination, comprising
a modulator for modulating the phase of an RZ carrier in accordance with said digital data; and
means for transmitting the output of said modulator from said originating location to said remote destination via a dispersion managed optical transmission medium.

4. The invention defined in claim 3 wherein said modulator is a PSK modulator.

5. The invention defined in claim 3 wherein said modulator is a DPSK modulator.

6. The invention defined in claim 3 wherein said modulator is a QPSK modulator.

7. The invention defined in claim 3 wherein said dispersion managed optical transmission medium is a long haul transmission medium adapted for the transmission of solitons.

8. The invention defined in claim 3 wherein said dispersion managed optical transmission medium is arranged to use quasi-linear transmission with very short (compared to the bit period) pulses that disperse very quickly as they propagate along said transmission medium.

9. The invention defined in claim 3 wherein said RZ carrier has a first wavelength, and wherein said arrangement further includes a wavelength division multiplexer arranged to combine the output of said modulator with other phase modulated signals having RZ carriers with different wavelengths.

10. The invention defined in claim 3 wherein said modulator is a LiNbO3 phase modulator.

11. The invention defined in claim 3 wherein said modulator is a LiNbO3 Mach-Zehnder phase modulator.

12. The invention defined in claim 3 wherein said remote location includes a delay demodulator.

13. The invention defined in claim 3 wherein said remote location includes a balanced receiver for recovering said input data from said phase modulated signal.

14. The invention defined in claim 3 wherein said arrangement includes means for amplifying the optical signal output from said transmission means to compensate for losses occurring in said optical transmission medium.

15. The invention defined in claim 14 wherein said amplifying means includes discrete or distributed EDFA or Raman amplification.

16. An optical communication method for transmitting input data from a transmitter to a remote receiver, comprising the steps of
encoding said input data by modulating the phase of a RZ carrier in accordance with said input data, and
transmitting said phase modulated RZ carrier from said transmitter to said receiver via a dispersion managed optical transmission medium.

17. A optical communication method comprising the steps of
generating an RZ carrier signal,
modulating the phase of said RZ carrier signal in accordance with an input data stream, and
applying the phase modulated signal generated in said modulating step to a dispersion managed optical transmission link.

18. An method for transmitting digital data from an originating location to a remote destination, comprising the steps of
modulating the phase of an RZ carrier in accordance with said digital data; and
transmitting the signal generated in said modulating step from said originating location to said remote destination via a dispersion managed optical transmission medium.
